(19) United States
(12) Patent Application Publication
(10) Pub. No.: US 2008/0228348 A1
(43) Pub. Date: Sep. 18, 2008

(54) METHOD FOR MANAGING VEHICLE STATE USING CAR MEDIA PLAYER AND COMPUTER-READABLE MEDIUM HAVING THEREON PROGRAM PERFORMING FUNCTION EMBODYING THE SAME

(75) Inventor: Hoo-Sung Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: HYUNDAI AUTONET, Gyeonggi-do (KR)

(21) Appl. No.: 12/047,595

(22) Filed: Mar. 13, 2008

(30) Foreign Application Priority Data
Mar. 13, 2007 (KR) 10-2007-0024345

(51) Int. Cl. G01M 17/00; G06F 19/00; B60Q 1/00

(52) U.S. Cl. 701/35; 701/29; 340/457

(57) ABSTRACT

Provided is a method for managing a vehicle state using a car media player. The method includes the steps of: (a) acquiring information on states of vehicle parts from a plurality of sensors, installed in the respective vehicle parts, through a dedicated vehicle network; (b) generating vehicle management information based on the acquired information on the states of the vehicle parts; and (c) notifying information necessary for repair of the vehicle based on the vehicle management information. Information on a vehicle state is received from a dedicated vehicle network using a typical car media player, and a vehicle state management such as replacement of vehicle parts is performed based on the information on the vehicle state. Therefore, a driver can reduce a cost of installing a separate vehicle state management device and need not separately perform a vehicle state management such as replacement time of vehicle parts. A vehicle repair shop can reduce time and cost of inspecting a vehicle state, and can minimize resource waste and cost loss, which are caused by too frequent replacement of vehicle parts. Due to the timely replacement of vehicle parts, the vehicle state can be optimally managed. Thus, the risk of vehicle accidents can decrease and the life span of the vehicle can increase.

### CROSS-REFERENCE TO RELATED APPLICATIONS

This application claims priority under 35 U.S.C. §119 to Korean Patent Application No. 10-2007-24345, filed on Mar. 13, 2007, the disclosure of which is incorporated herein by reference in its entirety.

### BACKGROUND OF THE INVENTION

1. Field of the Invention

The present disclosure relates to a method for managing a vehicle state using a car media player and a computer-readable medium having thereon a program performing functions embodying the same. In particular, information on a vehicle state is received from a dedicated vehicle network using a typical car media player, and a vehicle state management such as replacement of vehicle parts is performed based on the information on the vehicle state. Therefore, a driver can reduce a cost of installing a separate vehicle state management device and need not separately perform a vehicle state management such as replacement time of vehicle parts. A vehicle repair shop can reduce time and cost of inspecting a vehicle state, and can minimize resource waste and cost loss, which are caused by too frequent replacement of vehicle parts. Due to the timely replacement of vehicle parts, the vehicle state can be optimally managed. Thus, the risk of vehicle accidents can decrease and the life span of the vehicle can increase.

2. Description of the Related Art

A vehicle is made of a variety of parts. Since these vehicle parts have a different replacement time, it is not easy for drivers to remember the replacement time of all vehicle parts. If the vehicle parts are not replaced at the proper time, the life span of the vehicle parts may be reduced or the vehicle may malfunction, increasing the risk of vehicle accidents. Generally, drivers manage the vehicle parts by themselves using a car-keeping book or periodically request a vehicle repair shop to repair or manage the vehicle parts.

However, in the case where the drivers manage the vehicle parts by themselves, they must check the states of all vehicle parts but it is difficult for the drivers who do not have knowledge of the vehicle. Furthermore, it takes much time to check the states of the vehicle parts. In worse cases, it may take much more time to check the states of the vehicle parts when a driver loses the car-keeping book.

In the case where the vehicle is managed at the vehicle repair shop, a mechanic must check the states of all vehicle parts. Thus, it takes much time to manage the vehicle and the maintenance cost also increases.

A related art vehicle management technology indicates an engine malfunction by detecting a fuel level or an engine temperature through a dashboard installed in a vehicle, or indicates a normal/abnormal operation of an engine.

However, functions of indicating states of other vehicle parts have not been provided because their implementations are too expensive and complicated. Examples of such functions include a function of checking and indicating a remaining amount of an engine oil, a function of checking a wear degree of a power window gear and indicating it to the driver, a function of checking a wear degree of a tire and indicating its replacement time, a function of checking and indicating a remaining battery level, and a function of indicating a wear degree of a wiper.

Regarding these vehicle parts, the drivers must check a traveling distance or a vehicle usage period by themselves, remember the replacement time, directly replace the vehicle parts or request the auto repair shop to replace the vehicle parts. When the vehicle parts get out of order, they must be replaced through the repair of the vehicle.

In the case of express companies, not individual drivers, for example, taxi, bus or truck companies, which deliver passengers or goods, they must check states of vehicle parts with respect to a large number of vehicles, and replace defective parts at the proper time in order to maximize the life span of the vehicle. However, in most cases, special engineers take full responsibility for managing the large number of the vehicles, resulting in the increase of maintenance cost.

In addition, a vehicle state management apparatus which can check the states of the vehicle parts and inform the replacement time must be configured to receive states of the vehicle parts by wiring of the vehicle parts. In this case, a manufacturing cost and an assembling cost will increase because of complicated wire connections and addition of separate devices.

### SUMMARY

Therefore, an object of the present invention is to provide a method for managing a vehicle state using a car media player and a computer-readable medium having thereon a program performing functions embodying the same. In particular, information on a vehicle state is received from a dedicated vehicle network using a typical car media player, and a vehicle state management such as replacement of vehicle parts is performed based on the information on the vehicle state. Therefore, a driver can reduce a cost of installing a separate vehicle state management device and need not separately perform a vehicle state management such as replacement time of vehicle parts. A vehicle repair shop can reduce time and cost of inspecting a vehicle state, and can minimize resource waste and cost loss, which are caused by too frequent replacement of vehicle parts. Due to the timely replacement of vehicle parts, the vehicle state can be optimally managed. Thus, the risk of vehicle accidents can decrease and the life span of the vehicle can increase.

To achieve these and other advantages and in accordance with the purpose(s) of the present invention as embodied and broadly described herein, a method for managing a vehicle state using a car media player in accordance with an aspect of the present invention includes: (a) acquiring information on states of vehicle parts from a plurality of sensors, installed in the respective vehicle parts, through a dedicated vehicle network; (b) generating vehicle management information based on the acquired information on the states of the vehicle parts; and (c) notifying information necessary for repair of the vehicle based on the vehicle management information.

The step (b) may include the step of: (b-1) determining vehicle parts to be repaired by comparing the acquired information on the states of the vehicle parts with repair conditions previously defined in the car media player, and generating the vehicle management information based on the determination result.

The step (c) may include the step of: (c-1) providing the information necessary for the repair of the vehicle to a driver through an audio output or a graphic display of the car media player.

The step (c) may include the step of: (c-2) transmitting the information necessary for the repair of the vehicle to a driver's mobile communication terminal using a short range wireless communication protocol installed in the car media.

The mobile communication terminal may transmit information on repair reservation in an SMS message format by using a telephone number of a vehicle repair shop previously designated.

When a terminal of a previously designated vehicle repair shop supports the short range wireless communication protocol, the mobile communication terminal may transmit the information necessary for the repair of the vehicle to the terminal of the vehicle repair shop using the short range wireless communication protocol.

The step (c) may include the step of: (c-3) transmitting the information necessary for the repair of the vehicle to a terminal of a previously designated vehicle repair shop using a short range wireless communication protocol when the terminal of the vehicle repair shop supports the short range wireless communication protocol installed in the car media player.

The method may further include the step of: (d) updating the vehicle management information after the vehicle is repaired based on the information necessary for the repair of the vehicle.

The step (d) may include the step of: (d-1) storing a history of the repair.

Furthermore, there is provided a computer-readable medium having thereon a program performing functions embodying the method for managing the vehicle state using the car media player.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a flowchart illustrating a method for managing a vehicle state using a car media player according to an embodiment of the present invention.

### DETAILED DESCRIPTION OF EMBODIMENTS

Hereinafter, specific embodiments will be described in detail with reference to the accompanying drawings.

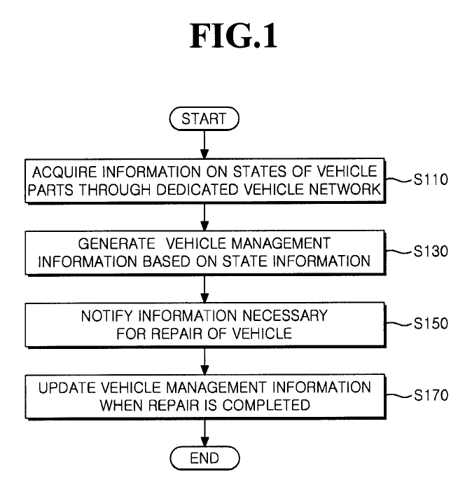

FIG. 1 is a flowchart illustrating a method for managing a vehicle state using a car media player according to an embodiment of the present invention.

Referring to FIG. 1, information on states of vehicle parts is acquired from a plurality of sensors, installed in respective vehicle parts, through a dedicated vehicle network in operation S110.

Since the information on the states of the vehicle parts is acquired through the dedicated vehicle network such as a MOST or CAN network, complicated works such as wiring are reduced, compared with the case of using a separate vehicle state management device. Furthermore, the implementation cost is also reduced because the car media player is used.

The sensors are installed in the respective vehicle parts and transmit the state information to the car media player through the dedicated vehicle network.

For example, a mileage record data can be acquired from a sensor installed in a mileage recorder.

In addition, data indicating a normal/abnormal operation of the vehicle can be acquired through a sensor installed in an electronic control unit (ECU), such as ABS or ESP.

These data constitute the state information.

In operation S130, vehicle management information is generated based on the acquired state information.

Vehicle parts to be repaired can be determined by comparing the state information acquired in operation S110 with the repair conditions previously stored in the car media player.

If the exchange of engine oil or brake pad is carried out at constant traveling distance intervals, these conditions will become the repair conditions.

In operation S150, information necessary for the repair of the vehicle is notified based on the vehicle management information generated in operation S130.

The information necessary for the repair of the vehicle may include a list of parts required to be repaired, for example, a brake pad required to be replaced because it is worn, or engine oil required to be replaced. Also, the information may include state information of the vehicle parts in order for appropriate repair operations of the vehicle repair shop.

The information necessary for the repair of the vehicle may be provided to the drivers through an audio output or a graphic display of the car media player.

That is, a previously stored audio message “the brake pad is worn, please replace the break pad” may be output through a speaker of the car media player, or the message may be display on an LCD screen of the car media player.

Furthermore, the information necessary for the repair of the vehicle may be transmitted to a driver's mobile communication terminal using a short range wireless communication protocol installed in the car media.

For example, if a Bluetooth communication module is installed in the car media player and a communication module supporting the Bluetooth protocol is installed in the driver's mobile communication terminal, the information necessary for the repair of the vehicle can be automatically transmitted to the driver's mobile communication terminal using the Bluetooth protocol.

In this case, the mobile communication terminal can previously store a telephone number of a vehicle repair shop and confirm a repair reservation by sending the information necessary for the repair of the vehicle to the vehicle repair shop in an SMS message format when the information necessary for the repair of the vehicle is received from the car media player.

When the driver visits the vehicle repair shop after checking the information necessary for the repair of the vehicle through the car media player or the mobile communication terminal, he or she can transmit the information stored in his or her mobile communication terminal to a terminal of the vehicle repair shop.

For example, when the terminal of the vehicle repair shop supports the Bluetooth communication, the information necessary for the repair of the vehicle can be transmitted to the terminal of the vehicle repair shop using the Bluetooth protocol.

In this case, the vehicle repair shop can reduce a diagnosis time because the necessary information can be obtained without checking the states of every vehicle parts.

When the driver visits the vehicle repair shop, the information necessary for the repair of the vehicle, which is stored in the car media player, can be directly transmitted to the terminal of the vehicle repair shop. For example, when the terminal of the vehicle repair shop supports the Bluetooth communication, the information necessary for the repair of the vehicle can be transmitted from the car media player to the terminal of the vehicle repair shop using the Bluetooth protocol.

After the information necessary for the repair of the vehicle is notified in operation S150 and the vehicle is repaired, the vehicle management information generated in operation S130 is updated in operation in S170.

That is, since the state of the vehicle part is changed when the repair is completed, the vehicle management information is updated. In this case, the repair history such as the replacement of the vehicle parts can be additionally stored in a car-keeping book form.

Furthermore, the present invention provides a computer-readable medium having thereon a program performing functions embodying the method for managing the vehicle state using the car media player.

The invention can also provide a computer-readable medium having thereon a program performing functions embodying the method for managing the vehicle state using a car media player.

The computer-readable medium is any data storage device that can store data which can be thereafter read by a computer system. Examples of the computer-readable medium include memory devices such as ROMs or RAMs, storage devices such as CD-ROMs or DVD-ROMs, magnetic recording media such as magnetic tapes or floppy disks, and optical data storage media.

A detailed description of the computer-readable medium will be omitted because it is substantially equal to that of the method for managing the vehicle state using the car media player.

As described above, information on a vehicle state is received from a dedicated vehicle network using a typical car media player, and a vehicle state management such as replacement of vehicle parts is performed based on the information on the vehicle state. Therefore, a driver can reduce a cost of installing a separate vehicle state management device and need not separately perform a vehicle state management such as replacement time of vehicle parts. A vehicle repair shop can reduce time and cost of inspecting a vehicle state, and can minimize resource waste and cost loss, which are caused by too frequent replacement of vehicle parts. Due to the timely replacement of vehicle parts, the vehicle state can be optimally managed. Thus, the risk of vehicle accidents can decrease and the life span of the vehicle can increase.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A method for managing a vehicle state using a car media player, the method comprising the steps of:
(a) acquiring information on states of vehicle parts from a plurality of sensors, installed in the respective vehicle parts, through a dedicated vehicle network;
(b) generating vehicle management information based on the acquired information on the states of the vehicle parts; and
(c) notifying information necessary for repair of the vehicle based on the vehicle management information.

2. The method of claim 1, wherein the step (b) comprises the step of:
(b-1) determining vehicle parts to be repaired by comparing the acquired information on the states of the vehicle parts with repair conditions previously defined in the car media player, and generating the vehicle management information based on the determination result.

3. The method of claim 2, wherein the step (c) comprises the step of:
(c-1) providing the information necessary for the repair of the vehicle to a driver through an audio output or a graphic display of the car media player.

4. The method of claim 2, wherein the step (c) comprises the step of:
(c-2) transmitting the information necessary for the repair of the vehicle to a driver's mobile communication terminal using a short range wireless communication protocol installed in the car media.

5. The method of claim 4, wherein the mobile communication terminal transmits information on repair reservation in an SMS message format by using a telephone number of a vehicle repair shop previously designated.

6. The method of claim 4, wherein when a terminal of a previously designated vehicle repair shop supports the short range wireless communication protocol, the mobile communication terminal transmits the information necessary for the repair of the vehicle to the terminal of the vehicle repair shop using the short range wireless communication protocol.

7. The method of claim 2, wherein the step (c) comprises the step of:
(c-3) transmitting the information necessary for the repair of the vehicle to a terminal of a previously designated vehicle repair shop using a short range wireless communication protocol when the terminal of the vehicle repair shop supports the short range wireless communication protocol installed in the car media player.

8. The method of claim 1, further comprising the step of:
(d) updating the vehicle management information after the vehicle is repaired based on the information necessary for the repair of the vehicle.

9. The method of claim 8, wherein the step (d) comprises the step of:
(d-1) storing a history of the repair.

10. A computer-readable medium having thereon a program performing functions embodying the method for managing the vehicle state using the car media player according to any one of claims 1 through 9.
